(19) United States
(12) Patent Application Publication
(10) Pub. No.: US 2010/0162626 A1
(43) Pub. Date: Jul. 1, 2010

(54) ADIABATIC REACTOR AND A PROCESS AND A SYSTEM FOR PRODUCING A METHANE-RICH GAS IN SUCH ADIABATIC REACTOR

(76) Inventors: Lloyd Anthony CLOMBURG, JR., Houston, TX (US); Anand NILEKAR, Houston, TX (US)

Correspondence Address: SHELL OIL COMPANY, P O BOX 2463, HOUSTON, TX, 772522463, US

(21) Appl. No.: 12/649,150

(22) Filed: Dec. 29, 2009

Related U.S. Application Data
(60) Provisional application No. 61/141,979, filed on Dec. 31, 2008.

(51) Int. Cl. C10L 3/10; B01J 19/00

(52) U.S. Cl. 48/197 FM; 422/197

(57) ABSTRACT

An adiabatic reactor comprising a first inlet and a first outlet defining a first flowpath between the first inlet and the first outlet and a second inlet and a second outlet defining a second flowpath between the second inlet and the second outlet, wherein the first flowpath and the second flowpath are directed in opposite directions; wherein both the first flowpath and the second flowpath comprise a catalyst; and wherein at least part of the first flowpath and at least part of the second flowpath are thermally connected via a wall separating the first flowpath from the second flowpath.

In addition a methanation process and system using the adiabatic reactor is provided.

This application claims the benefit of U.S. Provisional Application No. 61/141,979 filed Dec. 31, 2008, which is incorporated herein by reference.

### TECHNICAL FIELD OF THE INVENTION

The invention relates to a specific adiabatic reactor and a process and a system for producing a methane-rich gas in this specific adiabatic reactor.

### BACKGROUND OF THE INVENTION

A methanation reaction is a catalytic reaction of hydrogen with carbon monoxide and/or carbon dioxide to produce a methane-rich gas. This methane-rich gas is sometimes also referred to as synthetic natural gas (SNG) and can be used as substitute gas for natural gas. In areas where there is little natural gas available, other sources of energy, such as coal or petroleum coke, may be partially oxidized in a gasification process to produce a gas comprising hydrogen and carbon monoxide. Such a gas comprising hydrogen and carbon monoxide is sometimes also referred to as synthesis gas. The synthesis gas can subsequently be used to produce synthetic natural gas (SNG) in a methanation process.

The methanation reaction proceeds, in the presence of a suitable methanation catalyst, in accordance with the following equations:

CO+3H₂═CH₄+H₂O+heat (1)

CO₂+4H₂═CH₄+2H₂O+heat (2).

The water formed during the reaction can, depending on the catalyst, temperature and concentrations present, subsequently react in-situ with carbon monoxide in a water-gas shift reaction in accordance with the following equation:

CO+H₂O═CO₂+H₂+heat (3)

Reaction (1) is considered the main reaction and reactions (2) and (3) are considered to be side reactions. All the reactions are exothermic.

The methanation reaction can be carried out in one or more adiabatic reactors. As only a partial conversion may be achieved in one adiabatic reactor, conventionally a series of adiabatic reactors is used in a methanation process.

As the methanation reaction is exothermic, the temperature of a reaction mixture will increase during passage through the adiabatic reactors. The methanation reactions are reversible and an increasing temperature will tend to shift the equilibrium towards a lower yield. When a series of adiabatic reactors is used, the effluent of an adiabatic reactor is therefore cooled before entering a subsequent adiabatic reactor, for example by using external heat exchangers. In addition, the temperature increase in a first adiabatic reactor is conventionally limited by diluting a feed stream entering the first adiabatic reactor with a stream containing methane. For this purpose a considerable portion of a product stream, comprising a methane-rich gas, generated in the first adiabatic reactor is cooled and recycled. For example, a feed stream to a first adiabatic reactor may be mixed with a recycle stream containing a methane-rich gas in a volume ratio of recycled stream to feed stream as high as about 6:1.

Due to this large recycle stream, a large volume of gas needs to be processed through the first adiabatic reactor. In addition the first adiabatic reactor needs additional volume to accommodate the ignition of the reactants and to initiate the reaction. As a consequence the first adiabatic reactor in a series of adiabatic reactors for producing a methane-rich gas conventionally has a large reactor volume that may be as high as about 600 or 700 cubic meters.

In a conventional methanation process the first adiabatic reactor further requires the highest metallurgical costs as in the first adiabatic reactor the highest reaction temperatures are reached. The combination of its size and the metallurgical requirements make the first adiabatic reactor the most expensive reactor in a series of adiabatic reactors for producing a methane-rich gas.

An example of a conventional methanation process is provided in the report titled “Haldor Topsøe's Recycle Energy-efficient methanation process” which is available from the website of Haldor Topsøe, www.topsoe.com. In the methanation process illustrated on page 4 of the report a feed, comprising hydrogen and carbon monoxide, is fed to a series of three adiabatic reactors. After each adiabatic reactor the reactor effluent is cooled in a heat exchanger and part of the reactor effluent of the first adiabatic reactor is cooled, recycled and mixed with the feed.

GB2018818 describes a process for preparing a methane-rich gas in at least one adiabatically operating methanation reactor by converting a combination of a preheated synthesis gas stream and a recycle stream from the methanation reactor. The combined preheated synthesis gas stream and recycle stream are passed through a layer of shift catalyst directly before passage through a methanation catalyst.

It would be an advancement in the art to provide an adiabatic reactor and/or a process or system for producing a methane-rich gas that allows one to reduce the reactor volume of one or more of the adiabatic reactors. It would further be especially advantageous to be able to reduce the reactor volume of a first adiabatic methanation reactor in a series of adiabatic methanation reactors, as this first adiabatic reactor is the most expensive. In addition, it would be desirable to be able to reduce the reactor volume of one or more of the adiabatic reactors without increasing the inlet and/or outlet temperature of the reactor.

### SUMMARY OF THE INVENTION

The above has been achieved with the adiabatic reactor, the process and/or the system according to the invention.

Accordingly, the present invention provides an adiabatic reactor comprising a first inlet and a first outlet defining a first flowpath between the first inlet and the first outlet and a second inlet and a second outlet defining a second flowpath between the second inlet and the second outlet, wherein the first flowpath and the second flowpath are directed in opposite directions; wherein both the first flowpath and the second flowpath comprise a catalyst; and wherein at least part of the first flowpath and at least part of the second flowpath are thermally connected via a wall separating the first flowpath from the second flowpath.

The invention further provides a process for producing a methane-rich gas in an adiabatic reactor, wherein the adiabatic reactor comprises a first inlet and a first outlet defining a first flowpath between the first inlet and the first outlet and a second inlet and a second outlet defining a second flowpath between the second inlet and the second outlet, wherein the first flowpath and the second flowpath are directed in opposite directions; wherein both the first flowpath and the second flowpath comprise a methanation catalyst; and wherein at least part of the first flowpath and at least part of the second flowpath are thermally connected via a wall separating the first flow path from the second flowpath; and wherein the process comprises feeding a first feed stream, which first feed stream comprises carbon monoxide and hydrogen, to the first flowpath and converting at least part of the carbon monoxide and hydrogen of the first feed stream over the methanation catalyst in the first flowpath to produce a first product stream, which first product stream comprises a methane-rich gas; and feeding a second feed stream, which second feed stream comprises carbon monoxide and hydrogen, to the second flowpath and converting at least part of the carbon monoxide and hydrogen of the second feed stream over the methanation catalyst in the second flowpath to produce a second product stream, which second product stream comprises a methane-rich gas.

In addition the invention provides a system for producing a methane-rich gas including two or more adiabatic reactors that comprise a first inlet and a first outlet defining a first flowpath between the first inlet and the first outlet and a second inlet and a second outlet defining a second flowpath between the second inlet and the second outlet, wherein the first flowpath and the second flowpath are directed in opposite directions; wherein both the first flowpath and the second flowpath comprise a methanation catalyst; and wherein at least part of the first flowpath and at least part of the second flowpath are thermally connected via a wall separating the first flowpath from the second flowpath; and in which system the first outlet and/or the second outlet of at least one of the adiabatic reactors is directly or indirectly connected to the first inlet and/or second inlet of another adiabatic reactor.

The method, system and adiabatic reactor according to the invention advantageously allow one to reduce the reactor volume of one or more adiabatic reactors in a process or system for producing a methane-rich gas, without increasing the inlet and/or outlet temperature of such an adiabatic reactor. Alternatively, the adiabatic reactor, process and/or system according to the invention of the invention allows the use of a lower inlet temperature for a feed gas, whilst maintaining a specific reactor volume.

The adiabatic reactor, process and/or system according to the invention can reduce the reactor volume that is necessary to heat the reactants for the methanation reaction to ignition temperature and initiate the reaction, by using the heat of a product stream from the reactor to preheat a feed to the reactor. In addition, the adiabatic reactor, process and/or system according to the invention can increase the conversion of the reactants, after the reaction has initiated, by cooling a reaction mixture in the reactor with cold feed that is entering the reactor.

### BRIEF DESCRIPTION OF THE DRAWINGS

The adiabatic reactor, process and system according to the invention are illustrated with the following drawings.

FIG. 1a schematically shows an adiabatic reactor according to the invention.

FIG. 1b schematically shows a cross-section of a first embodiment of the adiabatic reactor of FIG. 1a.

FIG. 1c schematically shows a cross-section of a second embodiment of the adiabatic reactor of FIG. 1a.

FIG. 2 schematically shows a process and system according to the invention comprising three adiabatic reactors according to the invention.

FIG. 3a shows the temperature profile of the first adiabatic reactor in the process and system of FIG. 2.

FIG. 3b shows the temperature profile of the second adiabatic reactor in the process and system of FIG. 2.

FIG. 3c shows the temperature profile of the third adiabatic reactor in the process and system of FIG. 2.

FIG. 4 schematically shows a process according to the invention wherein a first product stream is used as a second feed stream.

FIG. 5 shows the temperature profile of the adiabatic reactor of FIG. 4.

FIG. 6a schematically shows an adiabatic reactor according to the invention comprising a first area that comprises a methanation catalyst and a second area, upstream of the first area that does not comprise any catalyst.

FIG. 6b schematically shows an adiabatic reactor according to the invention comprising a first area that comprises a methanation catalyst and a second area, upstream of the first area, that comprises a water-gas shift catalyst.

FIG. 6c schematically shows an adiabatic reactor according to the invention comprising a first area that comprises a methanation catalyst; a second area, upstream of the first area, that comprises a water-gas shift catalyst; and a third area, upstream of the first and the second area, that does not comprise any catalyst.

### DETAILED DESCRIPTION OF THE INVENTION

Within this patent application an adiabatic reactor is understood to be a reactor, which is not deliberately cooled or heated. In a preferred embodiment the adiabatic reactor is a reactor wherein there is substantially no loss or gain of heat with the surroundings of the reactor.

The adiabatic reactor according to the invention comprises a first inlet and a first outlet defining a first flowpath between the first inlet and the first outlet and a second inlet and a second outlet defining a second flowpath between the second inlet and the second outlet. By a flowpath is herein understood a path along which a flow of fluid, such as a liquid or a gas, can flow from the inlet to the outlet. The flowpath may for example comprise a space fluidly connected to the inlet and the outlet that is known by the skilled person to be capable of confining a fluid therein.

The adiabatic reactor may be any reactor allowing for at least two of such flowpaths.

In a preferred embodiment the adiabatic reactor is a multi-tubular adiabatic reactor comprising a reactor vessel with a vessel wall and tubes inside the vessel wall. The tubes are fluidly connected to a first inlet and a first outlet and comprise tube walls. In addition the reactor vessel comprises a space confined by the inside of the vessel wall and the outside of the tube walls, which space is fluidly connected to a second inlet and a second outlet. In this embodiment the first flowpath can be defined between the inlet and the outlet of the tubes and the second flowpath can be defined between the inlet and the outlet of the space confined by the inside of the vessel wall and the outside of the tube walls.

Any number of tubes and any diameter of the tubes that is known to the skilled person to be suitable for a multi-tubular reactor may be used. Preferably the adiabatic reactor comprises in the range from 10 to 10000 tubes, more preferably in the range from 100 to 2000 tubes. The tubes preferably have a diameter in the range from 1 cm to 15 cm, more preferably in the range from 1.5 cm to 10 cm, and most preferably in the range from 2 cm to 5 cm. Preferably the total volume in the tubes and the total volume of the space confined by the inside of the vessel wall and the outside of the tube walls is nearly equal or equal. More preferably the total cross sectional area for a flow through the tubes is the nearly equal or equal to the total cross sectional area for a flow through the space confined by the inside of the vessel wall and the outside of the tube walls.

In another preferred embodiment the adiabatic reactor comprises a first series of compartments, which first series of compartments can be fluidly connected to a first inlet and a first outlet, and a second series of compartments, which second series of compartments can be fluidly connected to a second inlet and a second outlet. The compartments are suitably separated from each other by compartment walls. In this embodiment the first flowpath can be comprised inside the first series of compartments between the first inlet and the first outlet and the second flowpath can be comprised inside the second series of compartments between the second inlet and the second outlet.

Preferably the compartments are situated parallel to each other. Further the compartments of the first series and the compartments of the second series are preferably ordered in an alternating manner. When the compartments are ordered in an alternating manner, any compartment of the first series, with the exception of any compartments that are situated next to the vessel wall of the reactor, can be neighbored on both sides by a compartment of the second series and vice versa.

The compartment walls may for example be formed by a series of parallel plates inside the reactor vessel, wherein each plate can separate a compartment of the first series from a compartment of the second series. The plates separating the compartments may be flat or may have a structure to allow for an increased heat-exchange. For example, the plates may have a wave-like structure.

Any number of compartments and any cross-section for the compartments that is known to the skilled person to be suitable for a multi-compartment reactor may be used. Preferably the adiabatic reactor comprises in the range from 2 to 10000, more preferably in the range from 10 to 2000, still more preferably in the range from 10 to 500 and most preferably in the range from 20 to 100 compartments. Preferably the total volume in the compartments of the first series and the total volume in the compartments of the second series are nearly equal or equal. More preferably, the total cross sectional area for a flow through the compartments of the first series is nearly equal or equal to the total cross sectional area for a flow through the compartments of the second series.

The first flowpath and the second flowpath are directed in opposite directions. In operation, the adiabatic reactor therefore allows a first flow of fluid in the first flowpath to flow counter-currently to a second flow of fluid in the second flowpath. Suitably the first flowpath and the second flowpath can be directed in opposite directions by locating the second inlet on a side of the reactor opposite of the side where the first inlet is located and by locating the second outlet on a side of the reactor opposite of the side where the first outlet is located.

Both the first flowpath and the second flowpath comprise a catalyst. The catalyst may be present in any form known by the skilled person to be suitable for catalyzing a reaction. The catalyst may for example be present in a fixed bed, or coated on a structure, such as a tubular, plate-like or spiral structure. Preferably the catalyst is present as a fixed bed. If the adiabatic reactor is a multi-tubular reactor, as for example describe herein above, the catalyst may be coated on the inside and/or outside surface of the tube walls or the catalyst may be coated on a spiral structure inside the tubes. If the adiabatic reactor is a multi-compartment reactor, as for example described herein above, the catalyst may be coated on one or both sides of a plate separating two compartments.

The volume of the first and/or second flowpath may be filled partly or completely with catalyst. Preferably the first and/or second flowpath is only partly filled with catalyst. Preferably in the range from 1 to 99 volume percent, more preferably in the range from 10 to 90 volume percent, still more preferably in the range from 20 to 80 volume percent and most preferably in the range from 25 to 75 volume percent of the first and/or second flowpath is filled with catalyst.

In a preferred embodiment the first and/or the second flowpath comprises a first area, that comprises catalyst, and a second area, upstream of the first area, that does not comprise any catalyst. The second area that does not comprise any catalyst can be used to preheat a flow of fluid before it is contacted with the catalyst in the first area. In this preferred embodiment both areas are suitably located in series along the wall separating the first flowpath from the second flowpath.

Each flowpath may comprise one or more catalysts. Preferably each flowpath comprises one or two catalysts. The catalyst(s) in the first flowpath may be different or the same as the catalyst(s) in the second flowpath. Preferably both flowpaths comprise the same catalyst or catalysts.

In a preferred embodiment, where the adiabatic reactor is to be used in a process for producing a methane-rich gas, the first flowpath and the second flowpath comprises one or more methanation catalyst(s). When used in a methanation reaction the reactor is herein also sometimes referred to as an adiabatic methanation reactor. The methanation catalyst(s) in the first flowpath and the methanation catalyst(s) in the second flowpath may be the same or different. In a preferred embodiment the methanation catalyst(s) in the first flowpath and the methanation catalyst(s) in the second flowpath are the same.

In another preferred embodiment, where the adiabatic reactor is to be used for a water-gas shift reaction, the first flowpath and the second flowpath comprise one or more water-gas shift catalyst(s).

In a further preferred embodiment one or both flowpaths comprise a methanation catalyst and a water-gas shift catalyst, wherein the water-gas shift catalyst is preferably located upstream of the methanation catalyst, as illustrated in GB2018818. Most preferably each flowpath comprises a combination of a methanation catalyst and a water-gas shift catalyst, wherein the water-gas shift catalyst is preferably located upstream of the methanation catalyst. Preferably the water-gas shift catalyst is present as a fixed bed of water-gas shift catalyst upstream of a fixed bed of methanation catalyst, such that a feed stream first passes the water-gas shift catalyst before coming into contact with the methanation catalyst. In a preferred embodiment, where the adiabatic reactor is a vertical reactor having a top-down flow, a layer of water-gas shift catalyst may simply be deposited onto a lower located layer of methanation catalyst.

Without wishing to be bound by any kind of theory, it is believed that the water-gas shift catalyst advantageously allows water and carbon monoxide in a feed stream to react thereby generating heat, which allows the gas mixture to increase quickly in temperature to a temperature high enough for the methanation reaction to initiate. For example, such a water-gas shift reaction may quickly increase the temperature of the gas mixture to a temperature above 300° C. but below 400° C.

The methanation catalyst may be any methanation catalyst known to be suitable for this purpose. The methanation catalyst may comprise nickel, cobalt, ruthenium or any combination thereof. Preferably the methanation catalyst comprises nickel. The methanation catalyst may comprise nickel, cobalt or ruthenium on a carrier, which carrier may comprise for example alumina, silica, magnesium, zirconia or mixtures thereof. Preferably the catalyst is a nickel containing catalyst, comprising preferably in the range from 10 wt % to 60 wt % nickel and more preferably in the range from 10 wt % to 30 wt % nickel. The nickel containing catalyst may further comprise some molybdenum as promotor.

Examples of suitable methanation catalysts include the catalysts exemplified in GB2018818 and Haldor Topsoe's MCR-2X methanation catalyst.

The water-gas shift catalyst may be any catalyst known to be suitable for such purpose. The water-gas shift catalyst may for example contain copper, zinc and/or chromium, optionally in the form of oxides and/or supported by a carrier.

In a further preferred embodiment the first and/or the second flowpath comprises a first area that comprises a methanation catalyst; a second area that comprises a water-gas shift catalyst, upstream of the first area; and/or a third area that does not comprise any catalyst, upstream of the first area and/or the second area. The third area can be used to preheat a flow of fluid before it is contacted with any of the catalysts. In this preferred embodiment all areas are suitably located in series along the wall separating the first flowpath from the second flowpath.

At least part of the first flowpath and at least part of the second flowpath are thermally connected via a wall separating the first flowpath from the second flowpath.

By being thermally connected is understood that the wall allows for the exchange of heat between the first flowpath and the second flowpath. The wall separating the first flowpath from the second flowpath preferably comprises a heat-conducting material. Preferably essentially all parts of the wall separating the first flowpath from the second flowpath consist of heat-conducting material. For example, the wall may comprise a metal such as stainless steel, which is capable of conducting heat. Preferably the wall comprises a heat-conducting and pressure-resistant material, in order for the wall to withstand elevated pressures that may be used in a reaction. In operation of the adiabatic reactor, heat generated by a flow of fluid, such as liquid or gas, in the first flowpath can be used to warm a flow of fluid, such as liquid or gas, in the second flowpath and vice versa. Simultaneously, a flow of fluid, such as liquid or gas, in the first flowpath can be cooled by a flow of fluid, such as liquid or gas, in the second flowpath and vice versa.

If the adiabatic reactor is a multi-tubular reactor, as for example described herein above, at least part of the first flowpath and at least part of the second flowpath can be thermally connected via the walls of the tubes. The walls of the tubes can suitably be made of a heat-conducting material as described herein. If the adiabatic reactor is a multi-compartment reactor, as for example described herein above, at least part of the first flowpath and at least part of the second flowpath can be thermally connected via the compartment walls. The compartment walls, for example consisting of plates separating the compartments, can suitably be made of a heat-conducting material as described herein.

The adiabatic reactor according to the invention can be advantageous in any exothermic chemical reaction, including, but not limited to for example a methanation reaction or a water-gas shift reaction. Preferably the adiabatic reactor according to the invention is used for a methanation reaction.

The adiabatic reactor may be vertically oriented or horizontally oriented. Preferably the adiabatic reactor is horizontally oriented.

The invention further provides a process for producing a methane-rich gas in an adiabatic reactor as described herein above. Such a process for producing a methane-rich gas in an adiabatic reactor as claimed herein suitably comprises feeding a first feed stream, which first feed stream comprises carbon monoxide and hydrogen, to the first flowpath and converting at least part of the carbon monoxide and hydrogen of the first feed stream over the methanation catalyst in the first flowpath to produce a first product stream, which first product stream comprises a methane-rich gas; and feeding a second feed stream, which second feed stream comprises carbon monoxide and hydrogen, to the second flowpath and converting at least part of the carbon monoxide and hydrogen of the second feed stream over the methanation catalyst in the second flowpath to produce a second product stream, which second product stream comprises a methane-rich gas.

The first feed stream and/or second feed stream, comprising carbon monoxide and hydrogen, may comprise any gas containing carbon monoxide and hydrogen.

An example of a gas containing carbon monoxide and hydrogen is synthesis gas. Within this patent application synthesis gas is understood to be a gas comprising at least hydrogen and carbon monoxide. In addition, the synthesis gas may comprise other compounds such as carbon dioxide, water, nitrogen, argon and/or or sulphur containing compounds. Examples of sulphur containing compounds that may be present in synthesis gas include hydrogen sulphide and carbonyl sulphide.

Synthesis gas may be obtained by reacting a carbonaceous feed and an oxidant in a gasification reaction.

By a carbonaceous feed is understood a feed comprising carbon in some form. The carbonaceous feed may be any carbonaceous feed known by the skilled person to be suitable for the generation of synthesis gas. The carbonaceous feed may comprise solids, liquids and/or gases. Examples include coal, such as lignite (brown coal), bituminous coal, sub-bituminous coal, anthracite, bitumen, oil shale, oil sands, heavy oils, peat, biomass, petroleum refining residues, such as petroleum coke, asphalt, vacuum residue, or combinations thereof. In an advantageous embodiment, the synthesis gas is obtained by gasification of a solid carbonaceous feed that comprises coal or petroleum coke.

By an oxidant is understood a compound capable of oxidizing another compound. The oxidant may be any compound known by the skilled person to be capable of oxidizing a carbonaceous feed. The oxidant may for example comprise oxygen, air, oxygen-enriched air, carbon dioxide (in a reaction to generate carbon monoxide) or mixtures thereof. If an oxygen-containing gas is used as oxidant, the oxygen-containing gas used may be pure oxygen, mixtures of oxygen and steam, mixtures of oxygen and carbon dioxide, mixtures of oxygen and air or mixtures of pure oxygen, air and steam.

In a special embodiment the oxidant is an oxygen-containing gas containing more than 80 vol %, more than 85 vol %, more than 90 vol %, more than 95 vol % or more than 99 vol % oxygen. Substantially pure oxygen is preferred. Such substantially pure oxygen may for example be prepared by an air separation unit (ASU).

In some gasification processes, a temperature moderator may also be introduced into the reactor. Suitable moderators include steam and carbon dioxide.

The synthesis gas may be generated by reacting the carbonaceous feed with the oxidant according to any method known in the art. For example it may be generated by a gasification reaction in a gasification process.

In a preferred embodiment the synthesis gas is generated by a partial oxidation of a carbonaceous feed such as coal or petroleum coke with an oxygen-containing gas in a gasification reactor.

Synthesis gas leaving a gasification reactor is sometimes also referred to as raw synthesis gas. This raw synthesis gas may be cooled and cleaned in a number of downstream cooling and cleaning steps. The total of the gasification reactor and the cooling and cleaning steps is sometimes also referred to as a gasification unit.

Examples of suitable gasification processes, reactors for such gasification processes and gasification units are described in “Gasification” by Christopher Higman and Maarten van der Burgt, published by Elsevier (2003), especially chapters 4 and 5 respectively. Further examples of suitable gasification processes, reactors and units are described in US2006/0260191, WO2007125047, US20080172941, EP0722999, EP0661373, US20080142408, US20070011945, US20060260191 and U.S. Pat. No. 6,755,980.

The synthesis gas produced by reacting a carbonaceous feed and an oxidant in a gasification reaction may be cooled and cleaned before using it in the process of the invention. Synthesis gas leaving a gasification reactor can for example be cooled by direct quenching with water or steam, direct quenching with recycled synthesis gas, heat exchangers or a combination of such cooling steps, to produce a cooled synthesis gas. In the heat exchangers, heat may be recovered. This heat may be used to generate steam or superheated steam. Slag and/or other molten solids that may be present in the produced synthesis gas can suitably be discharged from the lower end of a gasification reactor. Cooled synthesis gas can be subjected to a dry solids removal, such as a cyclone or a high-pressure high-temperature ceramic filter, and/or a wet scrubbing process, to produce a cleaned synthesis gas.

In a preferred embodiment, the first feed stream and/or second feed stream has been desulfurized before feeding it into the adiabatic reactor. The preferably cooled and cleaned synthesis gas may thus be desulfurized to produce a desulfurized synthesis gas before being used in a first feed stream and/or second feed stream. The desulfurization may be carried out in a desulfurizing unit where sulfur containing compounds, such as hydrogen sulfide and carbonyl sulfide can be removed from the gas. Desulfurization may for example be achieved by a physical absorption process and/or a chemical solvent process. The synthesis gas may further be treated to reduce the carbon dioxide content of the synthesis gas. In a preferred embodiment carbon dioxide and/or sulphur containing compounds such as hydrogen sulphide and carbonyl sulphide, may be removed simultaneously in an acid gas removal unit to produce a so-called sweet synthesis gas.

In a preferred embodiment the first feed stream and/or second feed stream entering the adiabatic reactor has a molar ratio of hydrogen to carbon monoxide in the range from 0.5:1 to 10:1, preferably in the range from 1:1 to 5:1 and more preferably in the range from 2:1 to 4:1. Most preferably the first feed stream and/or second feed stream entering the adiabatic reactor has a molar ratio of hydrogen to carbon monoxide of about 3:1. It can be advantageous to use a water-gas shift reactor to improve the molar ratio of hydrogen to carbon monoxide of the first feed stream and/or second feed stream. In a preferred embodiment, therefore, the invention provides a process wherein the first feed stream and/or the second feed stream comprises a shifted synthesis gas and is obtained by reacting a carbonaceous feed and an oxidant in a gasification reaction to produce a synthesis gas comprising carbon monoxide and hydrogen; reacting at least part of the synthesis gas with water and/or steam in a water-gas shift reaction to produce a shifted synthesis gas; producing a first feed stream and/or a second feed stream from the shifted synthesis gas.

In the process according to the invention suitably at least part of the carbon monoxide and hydrogen of the first feed stream is converted over a methanation catalyst in the first flowpath to produce a first product stream comprising a methane-rich gas, and at least part of the carbon monoxide and hydrogen of the second feed stream is converted over the methanation catalyst in the second flowpath to produce a second product stream comprising a methane-rich gas.

By a methane-rich gas is understood a gas in which the methane content has been increased. A methane-rich gas is preferably a gas comprising more than 1 molar percent methane, more preferably a gas comprising more than 5 molar percent methane and most preferably a gas comprising more than 10 molar percent methane.

The first and/or second feed stream may enter the reactor at a temperature in the range from 100° C. to 500° C. In order to make full use of the advantages of the present invention, however, it is preferred that the first and/or second feed stream enters the reactor at a temperature in the range from 100° C. to 350° C., more preferably in the range from 150 to 300° C., and still more preferably in the range from 180° C. to 220° C. When the first and/or second feed stream has a temperature on the lower side of these ranges it is preferred for the flowpaths to comprise both a methanation catalyst as well as an additional water-gas shift catalyst upstream of the methanation catalyst as described herein above.

The first and/or second product stream may leave the reactor at a temperature in the range from 200° C. to 800° C., preferably in the range from 300° C. to 700° C., even more preferably in the range from 350° C. to 600° C. In order to make full use of the advantages of the present invention, it is preferred that the first and/or second feed stream enters the reactor at a temperature in the range from 100° C. to 350° C., more preferably in the range from 150 to 300° C., and that the first and/or second product stream leaves the reactor at a temperature in the range from 300° C. to 700° C. When a series of adiabatic reactors is used, the exit temperatures may vary per reactor. For example, for a first adiabatic reactor according to the invention in a series of adiabatic reactors the entrance temperature may lie in the range from 100° C. to 350° C. whilst the exit temperature may lie in the range from 500° C. to 700° C.; for a second adiabatic reactor according to the invention in a series of adiabatic reactors the entrance temperature may lie in the range from 100° C. to 350° C. whilst the exit temperature may lie in the range from 400° C. to 600° C.; and for a third adiabatic reactor according to the invention in a series of adiabatic reactors the entrance temperature may lie in the range from 100° C. to 350° C. whilst the exit temperature may lie in the range from 300° C. to 400° C.

Each flowpath comprises an inlet region, an outlet region and a hot zone in between the inlet and outlet regions. In the inlet region of the first flowpath, heat can be exchanged with the outlet region of the second flowpath and vice versa. In a preferred embodiment a first feed stream is heated by a second product stream, whereas this second product stream is simultaneously cooled by the first feed stream and a second feed stream is heated by a first product stream, whereas this first product stream is simultaneously cooled by the second feed stream.

In the inlet regions the temperature of a feed stream entering the reactor increases steeply from the inlet temperature to a temperature in the range from 400° C. to 900° C., preferably in the range from 500° C. to 800° C. and still more preferably in the range from 600° C. to 750° C. as it is heated by the methane-rich gas leaving the reactor. Simultaneously the temperature of a methane-rich gas in an outlet region of the reactor is cooled by the cold feed stream entering the reactor to a temperature in the range from 200° C. to 500° C., preferably from 250° C. to 450° C. and more preferably from 250° C. to 400° C.

In the hot zone in between the two inlet-outlet regions the temperature is preferably kept below 800° C., more preferably below 700° C. and still more preferably between 400° C. and 600° C.

The extent of heat exchange may be influenced by the flow rates of the gas flow through the flowpaths. In a preferred embodiment the flowrate of any gas flow through the first flowpath is nearly equal or equal to the flow rate of any gas flow through the second flowpath.

The flowrate of the first and/or second feed stream into the adiabatic reactor, on the basis of a plant producing 14.1 million standard cubic meters of methane-rich gas per day, is preferably equal to or less than 150 Kmol/sec and preferably at least 10 Kmol/sec.

In one preferred embodiment a first feed stream is partly converted by means of the first methanization catalyst to produce a first product stream of methane-rich gas comprising methane, carbon monoxide and hydrogen; and this first product stream of methane-rich gas is subsequently used as the second feed stream, which second feed stream is further converted by means of the second methanation catalyst to produce the second product stream of methane-rich gas. Preferably the first product stream of methane-rich gas is cooled before it is used as the second feed stream.

In another preferred embodiment a stream of feed gas is split to generate a first feed stream and a second feed stream, whereafter the first feed stream is at least partly converted in a first flowpath to produce a first product stream of methane-rich gas and a second feed stream is at least partly converted in a second flowpath to produce a second product stream of methane-rich gas; and subsequently the first product stream of methane-rich gas and the second product stream of methane-rich gas are combined to form a combined product stream. Preferably one part of the combined product stream is recycled to the adiabatic reactor and another part is used as end-product and/or forwarded to a subsequent adiabatic reactor.

The adiabatic reactor according to the invention may be part of a series of reactors used to convert a feed gas into a methane-rich gas. The adiabatic reactor may for example be used in combination with other conventional adiabatic reactors, multitubular reactors or a combination thereof. Preferably the adiabatic reactor according to the invention is used in a series of adiabatic reactors used to convert a feed gas into a methane-rich gas. Preferably at least the first reactor in such a series of adiabatic reactors is an adiabatic reactor according to the invention. More preferably at least two or all reactors in such a series of adiabatic reactors are adiabatic reactors according to the invention.

In a further preferred embodiment at least part of a first product stream of methane-rich gas; at least part of a second product stream of methane-rich gas; or at least part of a combination of a first product stream of methane-rich gas and a second product stream of methane-rich gas of the adiabatic reactor according to the invention is recycled to the adiabatic reactor. This preferred embodiment is especially advantageous when the adiabatic reactor is the first adiabatic reactor in a series of adiabatic reactors. In a still further preferred embodiment a series of adiabatic reactors according to the invention is used to convert a feed gas into a methane-rich gas, wherein part of the methane-rich synthesis gas produced by the first adiabatic reactor is recycled and part of the methane-rich synthesis gas produced by the first adiabatic reactor is forwarded to a subsequent reactor.

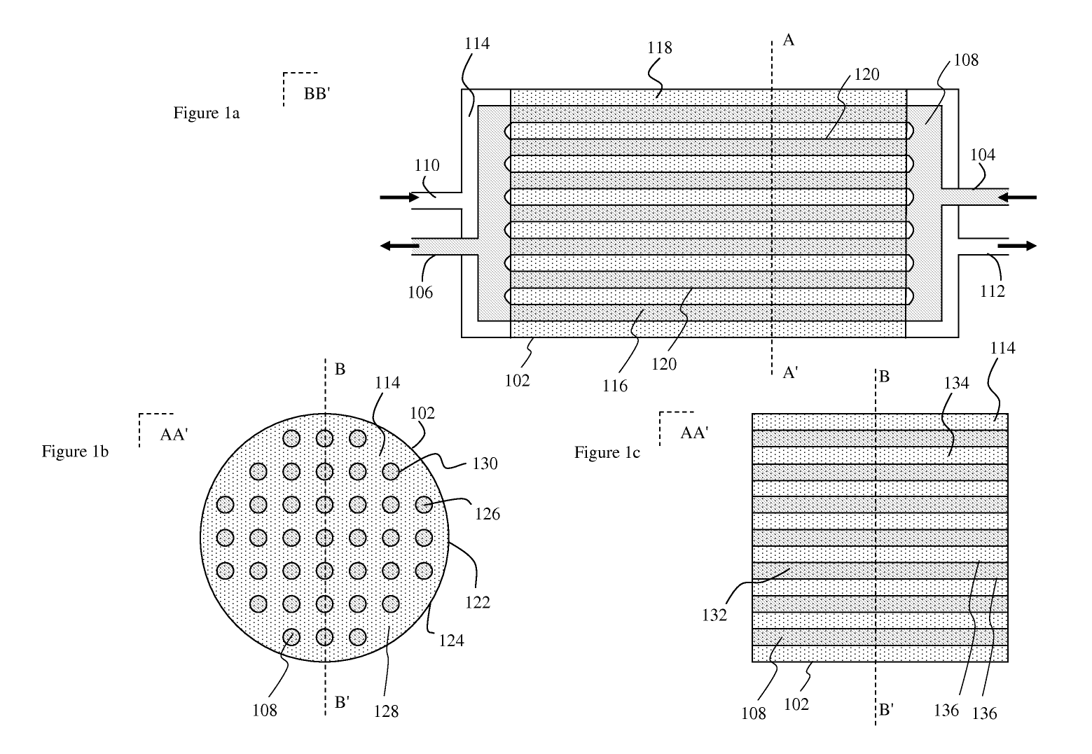

FIGS. 1a, 1b and 1c exemplify two embodiments of an adiabatic reactor according to the invention. The same features of the adiabatic reactor are indicated by the same numerals in FIGS. 1a, 1b and 1c. The adiabatic reactor (102) of FIG. 1a comprises a first inlet (104) on the right hand side and a first outlet (106) on the left hand side defining a first flowpath (108) between such first inlet (104) and first outlet (106). In addition the adiabatic reactor (102) comprises a second inlet (110) on the left hand side and a second outlet (112) on the right hand side defining a second flowpath (114) between such second inlet (110) and second outlet (112). The first inlet (104) and the second inlet (110) are located at opposite sides of the adiabatic reactor (102). In addition the first outlet (106) and the second outlet (112) are located at opposite sides of the adiabatic reactor (102). As a result the first flowpath (108) and the second flowpath (114) are directed in opposite directions. The first flowpath (108) comprises a first catalyst bed (116) comprising for example a methanation catalyst. The second flowpath (114) comprises a second catalyst bed (118) comprising for example a methanation catalyst. Parts of the first flowpath (108) and the second flowpath (114) are thermally connected via walls (120) separating the first flowpath (108) from the second flowpath (114).

In the embodiment of FIG. 1b the adiabatic reactor (102) comprising a reactor vessel (122) with a vessel wall (124) and tubes (126) inside the vessel wall. The first flowpath (108) is located inside the tubes (126) and the second flowpath (114) is located in the space (128) confined by the inside of the vessel wall and the outside of the tube walls. Parts of the first flowpath (108) and the second flowpath (114) are thermally connected via the walls of the tubes (130).

In the embodiment of FIG. 1c the adiabatic reactor (102) comprises a first series of compartments (132) and a second series of compartments (134). The compartments are separated from each other by compartment walls (136). In this embodiment the first flowpath (108) can be comprised inside the first series of compartments (132) and the second flowpath (114) can be comprised inside the second series of compartments (134). All compartments are in parallel to each other. In addition the compartments of the first series and the second series are stacked in an alternating manner. The walls (136) between the compartments may be flat, curved or waved.

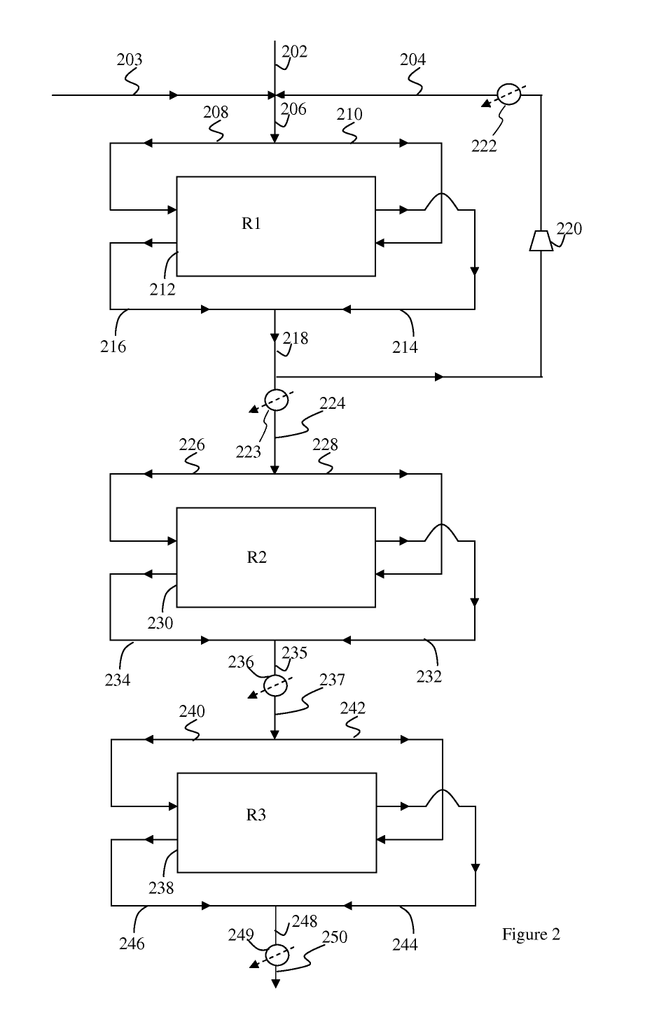

FIG. 2 shows a process wherein a stream of feed gas (202) comprising carbon monoxide and hydrogen is mixed with a recycle stream (204), comprising methane, carbon monoxide, hydrogen and water and a stream (203), comprising steam, to form a diluted feed stream (206) comprising methane, carbon monoxide, hydrogen and water. The diluted feed stream (206) is split into a first feed stream (208) and a second feed stream (210). The first feed stream (208) and the second feed stream (210) are each being fed to one side of the first adiabatic methanation reactor (212), such that the streams flow through the reactor (230) countercurrently. The first adiabatic methanation reactor (212) is an adiabatic reactor as illustrated in FIG. 1a and is hereafter also referred to as R1. A first product stream comprising methane-rich gas (214) leaves the reactor on the right hand side and a second product stream comprising methane-rich gas (216) leaves the reactor on the left hand side.

The first product stream (214) and the second product stream (216) are combined into a first combined product stream (218). Part of the combined product stream (218) is compressed in a compressor (220) and cooled in a heat exchanger (222) and mixed as recycle stream (204) with the stream of fresh feed gas (202) and the stream of steam (203) in order to prepare the diluted feed stream (206).

Another part of the combined product stream (218) is cooled in a heat exchanger (223) and forwarded to a second adiabatic reactor (230) as a cooled methane-rich stream (224). The cooled methane-rich stream (224) is split into a third feed stream (226) and a fourth feed stream (228), each stream being fed to one side of the second adiabatic methanation reactor (230), such that the streams flow through the reactor (230) counter-currently. The second adiabatic methanation reactor (230) is also an adiabatic reactor as illustrated in FIG. 1a and is hereafter also referred to as R2. A third product stream of methane-rich gas (232) leaves the reactor (230) on the right hand side and a fourth product stream of methane-rich gas (234) leaves the second reactor (230) on the left hand side. The third product stream (232) and the fourth product stream (234) are combined into a second combined product stream (235).

The second combined product stream (235) is cooled in heat exchanger (236) and forwarded to a third adiabatic reactor (238) as a cooled methane-rich stream (237). The cooled methane-rich stream (237) is split into a fifth feed stream (240) and a sixth feed stream (242), each stream being fed to one side of the third adiabatic methanation reactor (238) according to the invention such that the streams flow through the reactor (238) counter-currently. The third adiabatic methanation reactor (238) is also an adiabatic reactor as illustrated in FIG. 1a and is hereafter also referred to as R3. A fifth product stream of methane-rich gas (244) leaves the reactor (238) on the right hand side and a sixth product stream of methane-rich gas (246) leaves the second reactor (238) on the left hand side. The fifth product stream (244) and the sixth product stream (246) are combined into a final methane-rich product stream (248) which may be cooled in a heat exchanger (249) to prepare a cooled methane-rich product stream (250).

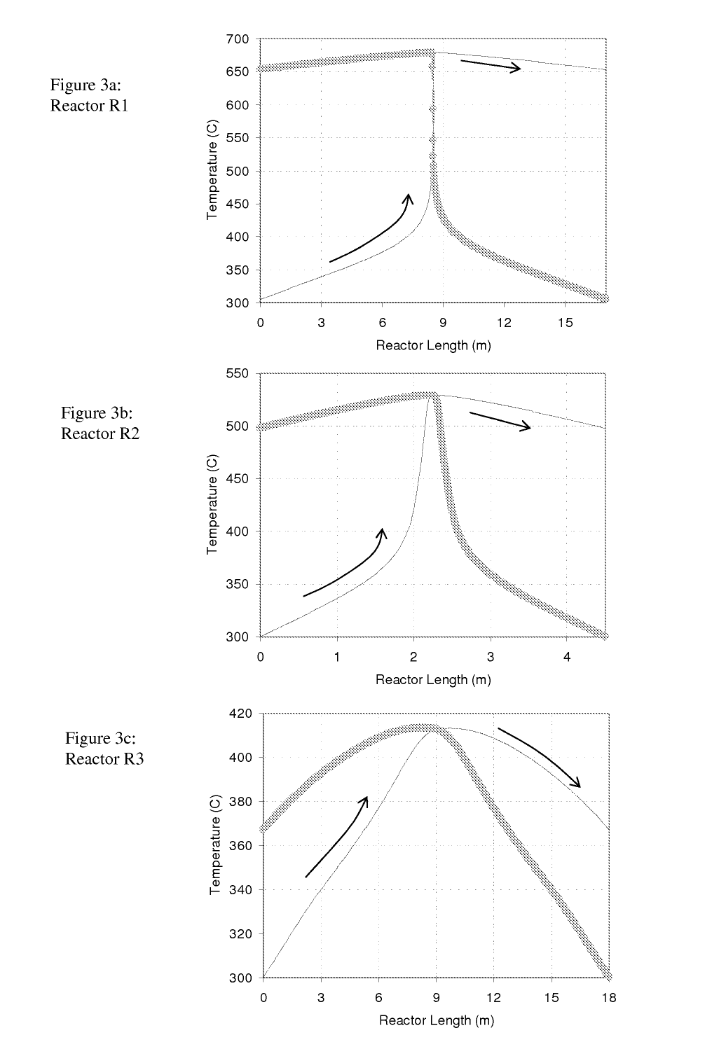

FIGS. 3a, 3b and 3c show the temperature profiles of respectively reactors R1, R2 and R3 in FIG. 2.

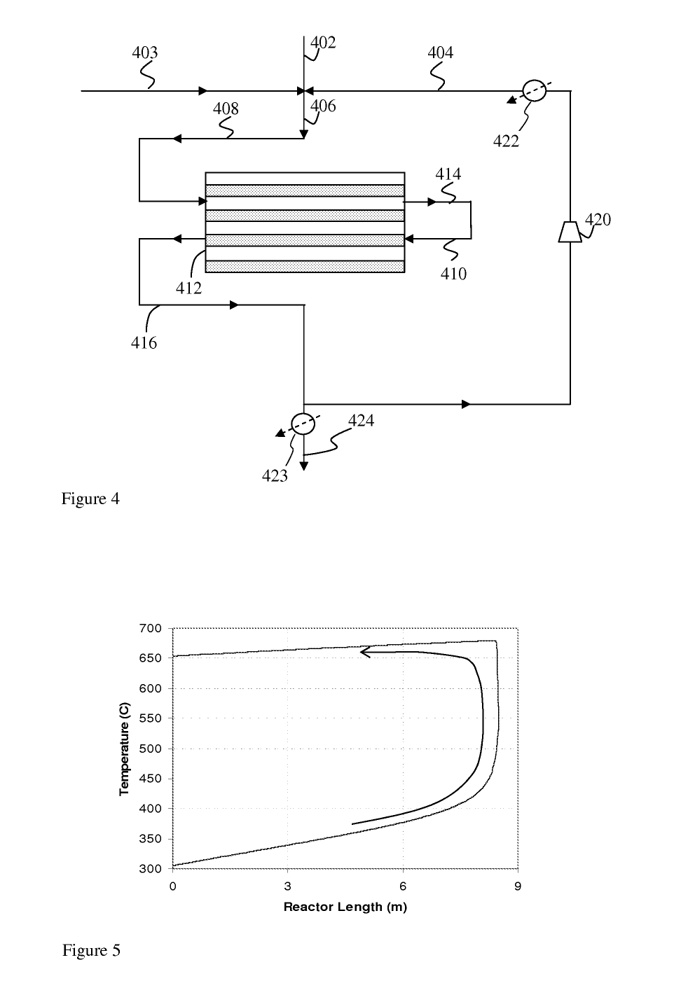

FIG. 4 shows another embodiment of the process according to the invention. A stream of feed gas (402) comprising carbon monoxide and hydrogen is mixed with a recycle stream (404) comprising methane, carbon monoxide, hydrogen and water, and a stream of steam (403) to form a diluted feed stream (406) comprising methane, carbon monoxide, hydrogen and water. The diluted feed stream (406) is forwarded as a first feed stream (408) to a first flowpath of an adiabatic methanation reactor (412) via the left hand side. The adiabatic methanation reactor (412) is an adiabatic reactor as illustrated in FIG. 1a. A first product stream (414) leaves the reactor on the right hand side. The first product stream (414) is subsequently fed back into a second flowpath of the adiabatic methanation reactor (412) as a second feed stream (410). The second feed stream (410) is fed to the adiabatic methanation reactor (412) from the right hand side such that the first feed stream (408) and the second feed stream (410) flow through the adiabatic reactor (412) countercurrently. A second product stream (416) leaves the adiabatic reactor (412) on the left hand side.

Part of the second product stream (416) is compressed in a compressor (420) and cooled in a heat exchanger (422) and mixed as recycle stream (404) with the stream of fresh feed gas (402) and a stream of steam (403) in order to prepare the diluted feed stream (406). Another part of the second product stream is cooled in a heat exchanger (423) to generate a cooled methane-rich product stream (424).

FIG. 5 shows the temperature profile of the adiabatic reactor in process 4.

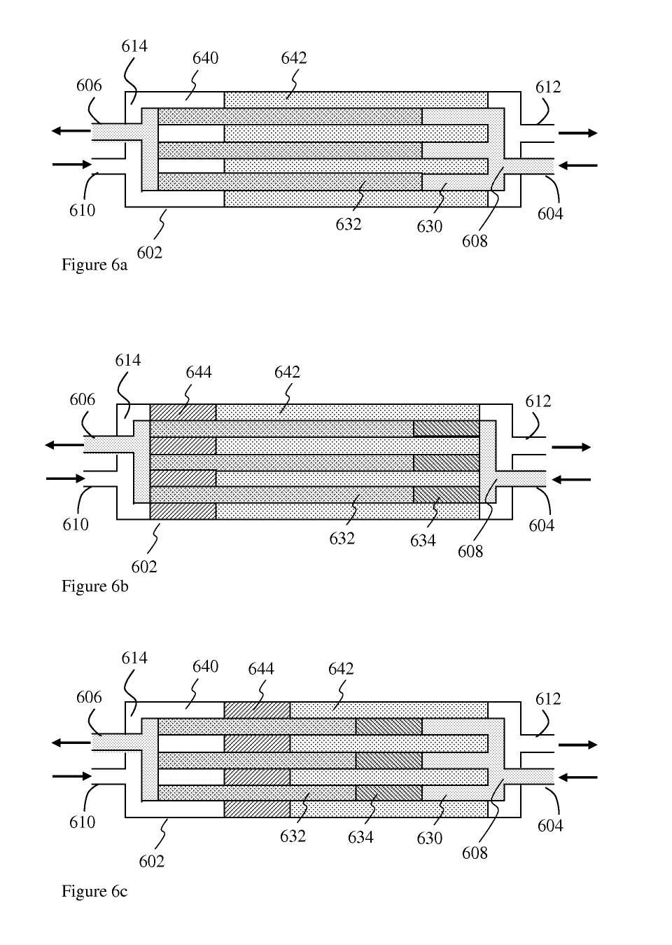

FIGS. 6a, 6b and 6c illustrates three specific embodiments of adiabatic reactors according to the invention. Features that are the same are given the same numerals.

In FIGS. 6a, 6b and 6c the adiabatic reactor (602) comprises a first inlet (604) on the right hand side and a first outlet (606) on the left hand side defining a first flowpath (608) between such first inlet (604) and first outlet (606). In addition the adiabatic reactor (602) comprises a second inlet (610) on the left hand side and a second outlet (612) on the right hand side defining a second flowpath (614) between such second inlet (610) and second outlet (612). The first inlet (604) and the second inlet (610) are located at opposite sides of the adiabatic reactor (602). In addition the first outlet (606) and the second outlet (612) are located at opposite sides of the adiabatic reactor (602). As a result the first flowpath (608) and the second flowpath (614) are directed in opposite directions.

The first flowpath (608) comprises an empty area (630) for preheating a first feed stream, upstream of a fixed bed containing a methanation catalyst (632) in which fixed bed carbon monoxide and hydrogen of the first feed stream can be converted to produce a first product stream comprising a methane-rich gas. The second flowpath also comprises an empty area (640) upstream of a fixed bed containing a methanation catalyst (642).

The adiabatic reactor of FIG. 6b differs from the adiabatic reactor of FIG. 6a in that the first flowpath comprises a second fixed bed containing a water-gas shift catalyst (634) upstream of the fixed bed containing a methanation catalyst (632) instead of an empty area (630). Also the second flowpath comprises a second fixed bed containing a water-gas shift catalyst (644) upstream of the fixed bed containing a methanation catalyst (642) instead of an empty area (640).

The adiabatic reactor of FIG. 6c differs from the adiabatic reactor of FIG. 6a in that the first flowpath comprises both an empty area (630) as well as a second fixed bed containing a water-gas shift catalyst (634) upstream of the fixed bed containing a methanation catalyst (632). Also the second flowpath comprises both an empty area (640) as well as a second fixed bed containing a water-gas shift catalyst (644) upstream of the fixed bed containing a methanation catalyst (642).

The invention is hereinbelow illustrated by the following non-limiting examples.

### Example 1

A computer calculation was made for a methane production according to a process as illustrated in FIG. 2 on the basis of a plant producing 5.5 million standard cubic meters of methane-rich gas per day, with the help of a simulation carried out in Aspen plus 2006.5. The kinetics used in the calculation were based on the article of Xu and Froment (AIChE Journal, volume 35 (1), page 88, 1989). The temperature profiles along the length of the first (R1), second (R2) and third (R3) adiabatic methanation reactor of FIG. 2 were calculated and illustrated in FIGS. 3a, 3b and 3c. The particulars of the inlet and outlet streams of the reactors are listed in table I.

TABLE I
Particulars of the inlet and outlet streams
of the reactors R1, R2 and R3 in FIG. 2

| | Inlet R1 | Outlet R1 | Outlet R2 | Outlet R3 |
|---|---|---|---|---|
| | (stream 206) | (stream 218 | (stream 235) | (stream 248) |
| Temperature | 305 | 653 | 498 | 367 |
| (° C.) | | | | |
| Pressure (bar) | 38.0 | 38.0 | 36.0 | 34.5 |
| Molar flowrate | 18.3 | 16.1 | 2.9 | 2.9 |
| (kmol/sec) | | | | |
| Mole fractions | | | | |
| (mol %) | | | | |
| carbon dioxide | 4.9 | 6.7 | 5.1 | 3.9 |
| carbon | 9.1 | 2.3 | 0.2 | 0.0 |
| monoxide | | | | |
| water | 23.6 | 33.0 | 42.7 | 46.7 |
| methane | 24.6 | 35.1 | 42.8 | 45.5 |
| hydrogen | 37.0 | 22.1 | 8.4 | 2.8 |
| nitrogen | 0.7 | 0.8 | 0.9 | 0.9 |

The process as illustrated in FIG. 2, using adiabatic reactors according to the invention as illustrated in FIG. 1a, was compared with a similar process using three conventional adiabatic reactors. In both processes the inlet temperatures of each reactor was maintained around 300° C. Subsequently a calculation was made wherein the outlet temperature of the first reactor was maintained around 653° C., the outlet temperature of the second reactor was maintained around 498° C. and the outlet temperature of the third reactor was maintained around 368° C.

In table II the exact outlet temperatures for the adiabatic reactors according to the invention and the conventional adiabatic reactors are provided.

TABLE II
Outlet temperatures for adiabatic reactors in the process
according to the invention and a conventional process.

| Outlet | | | |
|---|---|---|---|
| temperature (° C.) | Outlet R1 | Outlet R2 | Outlet R3 |
| conventional | 653.5 | 498.0 | 368.1 |
| according to | 653.4 | 497.7 | 367.0 |
| invention | | | |

The reactor volumes of the conventional adiabatic reactors and the adiabatic reactors according to the invention (as illustrated in FIG. 1a) were calculated and are listed in table III below.

TABLE III
Reactor volumes for adiabatic reactors in the process
according to the invention and a conventional process.

| Volumes | | |
|---|---|---|
| (cubic meters) | conventional | according to invention |
| R1 | 685 | 34 |
| R2 | 71 | 9 |
| R3 | 390 | 36 |

As illustrated in table III, the method, system and adiabatic reactor according to the invention advantageously allow one to reduce the reactor volume, whilst maintaining a specific inlet or outlet temperature for the reactor.

Alternatively if the same reactor volumes are used, a lower inlet temperature could be used for the method, system and adiabatic reactor according to the invention.

What is claimed is:

1. An adiabatic reactor comprising a first inlet and a first outlet defining a first flowpath between the first inlet and the first outlet and a second inlet and a second outlet defining a second flowpath between the second inlet and the second outlet,
wherein the first flowpath and the second flowpath are directed in opposite directions;
wherein both the first flowpath and the second flowpath comprise a catalyst; and
wherein at least part of the first flowpath and at least part of the second flowpath are thermally connected via a wall separating the first flowpath from the second flowpath.

2. The adiabatic reactor according to claim 1, wherein the adiabatic reactor is a multi-tubular adiabatic reactor comprising a reactor vessel with a vessel wall and tubes inside the vessel wall, which tubes are fluidly connected to an inlet and an outlet and which tubes comprise tube walls, and which reactor vessel further comprises a space confined by the inside of the vessel wall and the outside of the tube walls, which space is fluidly connected to an inlet and an outlet, wherein the first flowpath is defined between the inlet and the outlet of the tubes and wherein the second flowpath is defined between the inlet and the outlet of the space confined by the inside of the vessel wall and the outside of the tube walls; and wherein at least part of the first flowpath and at least part of the second flowpath are thermally connected via at least part of one or more of the tube walls.

3. The adiabatic reactor according to claim 1, wherein the adiabatic reactor comprises a first series of compartments, which first series of compartments is fluidly connected to an inlet and an outlet, and a second series of compartments, which second series of compartments is fluidly connected to an inlet and an outlet, and which compartments are separated from each other by compartment walls, wherein the first flowpath is comprised inside the first series of compartments and the second flowpath is comprised inside the second series of compartments; and wherein at least part of the first flowpath and at least part of the second flowpath are thermally connected via at least part of one or more compartment walls.

4. The adiabatic reactor according to claim 1, wherein the first and/or the second flowpath comprises a first area that comprises a methanation catalyst; and a second area that comprises a water-gas shift catalyst, upstream of the first area.

5. A process for producing a methane-rich gas in an adiabatic reactor,
wherein the adiabatic reactor comprises a first inlet and a first outlet defining a first flowpath between the first inlet and the first outlet and a second inlet and a second outlet defining a second flowpath between the second inlet and the second outlet, wherein the first flowpath and the second flowpath are directed in opposite directions; wherein both the first flowpath and the second flowpath comprise a methanation catalyst; and wherein at least part of the first flowpath and at least part of the second flowpath are thermally connected via a wall separating the first flowpath from the second flowpath; and
wherein the process comprises
feeding a first feed stream, which first feed stream comprises carbon monoxide and hydrogen, to the first flowpath and converting at least part of the carbon monoxide and hydrogen of the first feed stream over the methanation catalyst in the first flowpath to produce a first product stream, which first product stream comprises a methane-rich gas; and
feeding a second feed stream, which second feed stream comprises carbon monoxide and hydrogen, to the second flowpath and converting at least part of the carbon monoxide and hydrogen of the second feed stream over the methanation catalyst in the second flowpath to produce a second product stream, which second product stream comprises a methane-rich gas.

6. The process according to claim 5, wherein the first feed stream is heated by the second product stream whilst the second product stream is cooled by the first feed stream.

7. The process according to claim 6, wherein the second feed stream is heated by the first product stream whilst the first product stream is cooled by the second feed stream.

8. The process according to claim 5,
wherein part of the carbon monoxide and hydrogen of the first feed stream is converted over the methanation catalyst in the first flowpath to produce a first product stream comprising methane and unconverted carbon monoxide and unconverted hydrogen; and
wherein the first product stream, comprising unconverted carbon monoxide and unconverted hydrogen, is forwarded to the second flowpath as the second feed stream.

9. The process according to claim 8, wherein the first product stream is cooled before being forwarded to the second flowpath as the second feed stream.

10. The process according to claim 5, wherein a stream comprising carbon monoxide and hydrogen is split into the first feed stream and the second stream; and wherein the first product stream and the second product stream are combined to form a combined product stream.

11. The process according to claim 5, wherein at least part of the first product stream; at least part of the second product stream; or at least part of a combination of the first product stream and the second product stream, is recycled to the adiabatic reactor as part of the first feed stream and/or part of the second feed stream.

12. The process according to claim 5, wherein at least part of the first product stream; at least part of the second product stream; or at least part of a combination of the first product stream and the second product stream is forwarded to a subsequent reactor.

13. The process according to claim 5, wherein the first feed stream and/or the second feed stream is obtained by gasification of a carbonaceous feed.

14. The process according to claim 5, wherein the process further comprises
reacting a carbonaceous feed and an oxidant in a gasification reaction to produce a synthesis gas comprising carbon monoxide and hydrogen;
reacting at least part of the synthesis gas with water and/or steam in a water-gas shift reaction to produce a shifted synthesis gas;
producing a first feed stream and/or a second feed stream from the shifted synthesis gas.

15. A system for producing a methane-rich gas including two or more adiabatic reactors that each comprise a first inlet and a first outlet defining a first flowpath between the first inlet and the first outlet and a second inlet and a second outlet defining a second flowpath between the second inlet and the second outlet, wherein the first flowpath and the second flowpath are directed in opposite directions;
wherein both the first flowpath and the second flowpath comprise a methanation catalyst;
and wherein at least part of the first flowpath and at least part of the second flowpath are thermally connected via a wall separating the first flowpath from the second flowpath; and
in which system the first outlet and/or the second outlet of at least one of the adiabatic reactors is directly or indirectly connected to the first inlet and/or second inlet of another adiabatic reactor.
